(19) United States
(12) Patent Application Publication
(10) Pub. No.: US 2025/0021074 A1
(43) Pub. Date: Jan. 16, 2025

(54) METHOD FOR PROVIDING TOOL DATA RECORDS FOR MACHINING TOOLS

(71) Applicant: Juergen WIDMANN, Schwaebisch Gmuend (DE)

(72) Inventor: Juergen WIDMANN, Schwaebisch Gmuend (DE)

(21) Appl. No.: 18/903,871

(22) Filed: Oct. 1, 2024

Related U.S. Application Data
(63) Continuation of application No. PCT/EP2023/057832, filed on Mar. 27, 2023.

(30) Foreign Application Priority Data
Apr. 1, 2022 (DE) 10 2022 107 797.7

(51) Int. Cl. G05B 19/408; G05B 19/4097

(52) U.S. Cl. CPC G05B 19/408; G05B 19/4097; G05B 2219/32422

(57) ABSTRACT

A method for providing tool data records for machining tools. A global database is provided for receiving the tool data record. Tool information items are added to the tool data records by users and/or manufacturers of the machining tools. At least one tool data record is validated for a certain machining tool, based on a comparison of a plurality of tool information items concerning at least one comparable parameter of this tool.

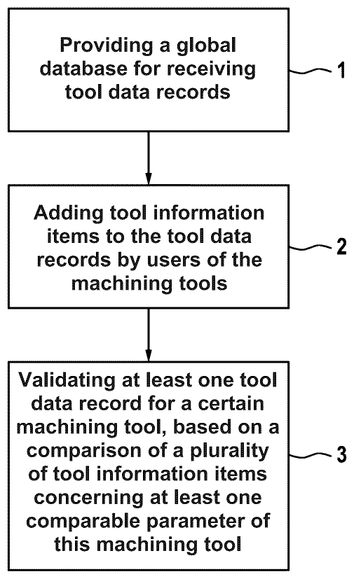

This nonprovisional application is a continuation of International Application No. PCT/EP2023/057832, which was filed on Mar. 27, 2023, and which claims priority to German Patent Application No. 10 2022 107 797.7, which was filed in Germany on Apr. 1, 2022, and which are both herein incorporated by reference.

### BACKGROUND OF THE INVENTION

### Field of the Invention

The invention relates to a method for providing tool data records for machining tools.

### Description of the Background Art

In present production processes in the machining industry, CNC-controlled machines that achieve an increasingly higher degree of automation are predominantly used. The automated process relies on tool data records, which are stored on a memory medium for individual machining tools used in the tool machine, for example turning tools, cutting heads with cutting inserts, or milling heads. The tool data records are provided, at least in part, by the suppliers of the tools, or may be obtained directly from the manufacturer in the form of data sheets.

German Patent application DE 10 2018 111 547 A1, which corresponds to US 2021/0240162, and which describes a method for using tool data records in an automated process of a CNC tool machine. After delivery and unique identification of the tool by the CNC tool machine, a tool data record uniquely assigned to the tool and stored on a memory medium is transmitted by the tool to the CNC tool machine. The form and the number of parameters provided for the individual tools sometimes differ significantly, depending on the manufacturer and/or supplier of the tool used, and often involve different, i.e., non-unique, designations for a parameter of the tool, and/or are not up to date. This has the drawback that the maintenance of the tool data records is very laborious.

German Patent application DE 10 2016 219 371 A1, which corresponds to US 2020/0041986, discloses a system for sharing device-related data with a database that is used for global storage of the tool data records. Tool data records, in particular machine parameters, of different machining units, for example CNC tool machines, may thus be transmitted to the database and transmitted from the database to the machining units; i.e., a tool data record is used by multiple machines.

Prior to storage of the transmitted tool data records in the global database, in order to avoid duplicate entries in the database it is checked whether a tool data record is already present for the uniquely identifiable tool that is transmitted with the tool data. This has the disadvantage that parameters that are possibly missing in the already stored tool data record of the tool are not supplemented, and the tool data records stored in the database are not checked for correctness, as a result of which incorrect parameters may be transferred to other machining units via the database.

### SUMMARY OF THE INVENTION

It is therefore an object of the present invention to provide a method that eliminates the disadvantages of the prior art described above.

This object is achieved in an example by a method for providing tool data records for machining tools having the following steps: providing a global database for receiving the tool data records; adding tool information items to the tool data records by a user and/or a manufacturer of the tools; and validating at least one tool data record for a certain machining tool, based on a comparison of a plurality of tool information items concerning at least one comparable parameter of this machining tool.

Tool data records are standardized in ISO 13399 and DIN 4000/4001, and include tool information in the form of individual physical parameters, for example the nominal diameter of a milling head, and also two-dimensional and three-dimensional digital data models of the machining tool, also referred to as a digital twin.

The tool information may be added manually by the user and/or manufacturer, or also via an automated method.

The validation of a tool data record is based on the comparison of multiple inputs of identical tool information items (parameters) belonging to a uniquely designated tool data record. Thus, for example, for a tool, for example a milling head, a user A may indicate the nominal diameter of the milling head using a unique identifier WK. Another user B may likewise input the nominal diameter of the milling head for the same tool, using the identifier WK. Based on these two independent inputs of the nominal diameter of the milling head (identical tool information) of the same tool, which is uniquely identifiable by the identifier WK, the nominal diameter of the milling head is thus validated. The greater the number of values for a tool information item (nominal diameter of the milling head) that are independently input, the greater is the basis for the validation and thus the integrity of the word for this tool information item stored in the global database. The validation is explained in greater detail below. The checking of the integrity of data may be referred to as ensuring the correctness (soundness) of data and the correct functioning of systems.

Within the meaning of the invention, the definition of a tool data record also can encompasses tool information that is helpful for utilizing the machining tool in tool machines, for example cutting speeds or service life of the machining tool. This tool information may be based, for example, on the experience gained by the user during use of the machining tools, and may advantageously be indicated in terms of the tool machine used and/or the material that is machined. Within the meaning of the invention, a user may be a company with several employees, referred to as individual users, a manufacturer, and/or a supplier of tools, or alternatively may be an individual.

Further tool information items of a machining tool with a uniquely identifiable tool data record may be the detailed machine parameters used for the machining tool, for example rotational speed, feed rate, infeed, or any other machine parameters used. The machine parameters are detected with regard to a likewise uniquely identifiable machining unit, which likewise is part of the tool data record.

In addition, information corresponding to the machine parameters, concerning the material (material data) of the part being machined, for example the name of the material, contained additives, or also physical properties such as the modulus of elasticity, may be added to the tool data record as tool information. The unique identification of the machining tool, and thus of a corresponding tool data record, is essential for the assignment of the tool information and the validation of the data based thereon.

Regardless of the origin of the tool information for the tool data records, in particular also for the machine parameters and material data, the tool data records may be stored in the global database, independently of the machine. The tool information may be adapted with specific values for the machine and/or for the tool itself only when the tool data record is optionally assigned to a specific machining unit. When the tool data records are assigned to a specific machining unit, the tool information, which is usually also stored in a separate measuring device for determining the present state of the tool, for example the diameter of a milling head that is reduced by wear, may be transmitted to the machining unit. Optionally, the tool information from the measuring device and the tool information from the database may also be combined before transmission to the machining unit. Instead of the nominal diameter of the milling head, for example only the value for the diameter of the milling head that is determined in the measuring device and that is relevant for the machining unit is transferred to the machining unit.

Furthermore, at least portions of the tool data records may be transmitted to users for use in the design and/or production of parts.

In particular, at least a portion of a tool data record may be transmitted directly to a machining unit that is defined as a user and/or to a CNC program for a machining unit for use in the manufacture of parts. Within the meaning of the invention, “directly” means that a connection and/or interface for transferring the data between the database and the machining unit are/is present.

The validation of the data within the scope of the method according to the invention, prior to use in a machining unit, prevents the use of incorrect data, regardless of whether the data are transmitted directly into the machining unit and/or a CNC program, or are loaded from the database by a user. Use of the validated data thus results in a reduction in the reject rate, in particular for adjusting or setting up a machining unit for a new part and/or adapting the machining unit from one part to another part, which has a positive effect on the setup times during manufacture of a part. The reduction in the reject rate and the setup times may advantageously decrease the production costs.

An information item concerning the status of the validation of the tool data record may also be included in the transmission of at least a portion of the tool data record to a user. The individual parameters of the tool data records may be validated based on the tool information that is input by the users. This status or the quality of the validation may also be transferred, so that based on the status, the user can conduct a risk assessment for use of the data. It is also conceivable to transmit, in addition to the quality of the validation, the contribution by certain users which is characterized by a particularly high level of quality of tool information that is input.

The status of the validation thus encompasses the integrity of the data, wherein in addition to the purely mathematical comparison of the data, the origin of the data may be included in the integrity. The integrity of the data advantageously supports the use and the exchange of experience between the various users of the provided tool data records. The origin of the tool information of the tool data records, taken into account in the integrity, may also be used, for example, as a trigger for automatically accepting a tool data record, or at least portions thereof, directly into a machining unit and/or a CNC program that controls the machining unit.

Within the meaning of the invention, “automatically” can include that during transmission from a machining unit and/or a CNC program to the database, or also during transmission from the database to the machining unit and/or the CNC program, data are suggested, at least by the program, to a user for transmission or are transmitted directly, i.e., without active agreement by the user.

The trigger may also be personalized, for example, so that each of the users themselves may determine the threshold value of the trigger. Thus, for example, different factories of a company may already classify portions of a tool data record, successfully used by one of the factories, as trustworthy. In contrast, a second company would not classify these tool data records per se as trustworthy.

In particular, the user may utilize a local database with an interface to the global database for addition and/or for transmission. The operator of the global database may provide a local database to a company (user), for example, in which the company can maintain primarily the tool data records that are used by the company. On the other hand, manufacturers and/or suppliers are preferably provided with tool information concerning the tool data records of the tools that they manufacture or market. These may be added directly into the global database. Alternatively, the manufacturer/supplier may likewise utilize a local database. This is advantageous in particular when the validated tool data records are also provided to the manufacturer and/or the supplier according to a contract, for example for transferring to their customers. An individual who only occasionally makes use of the addition of tool information as well as the transmission of at least portions of the tool data records may, in contrast to a company, preferably have direct access only to a predetermined area of the global database. In addition, a direct connection of the global database to a tool machine may also be set up, so that after the machining tool is identified, the tool machine may directly access parameters from the tool data record that are relevant for the manufacturing.

According to the invention, tool information that is input into the local database by the user may be automatically transmitted to the global database, so that the global database is directly provided with new tool information for validating the tool data records. By use of this procedure, also referred to as “swarm intelligence,” in which the information is utilized by a large number of users, the quality of the tool data records may be advantageously increased by the multitude of tool information that is input by different users. Alternatively, the transmission of the tool information may also be actively started, for example by pressing a button on a user interface.

Tool information items, in particular the machine parameters utilized during use of the tool, may be automatically transmitted from a machining unit and/or from a CNC program for a machining unit to the global database. This has the advantage that the typically manual input of the data into the local tool database is dispensed with, so that, for example, input errors may be avoided. For improving the data quality, the automatic transfer may be linked, for example, to enablement of the CNC program of the machining unit, which occurs only after a successful use.

In addition, the tool data records present in a local database may be at least partially updated with updated tool data records from the global database after an active request and/or agreement. The transmission of at least portions of the tool data records from the global database to the local database may thus be started by the user by an active request for new or updated tool data records for a specific tool. In particular, predetermined tool information items of the tool data record may also be requested or transmitted only by a selection by the user. Thus, certain tool information, for example cutting speeds, cannot be overwritten by the values stored in the global database, in particular by the user during use of the tools. Alternatively, each tool data record that is retrieved in a local database may be automatically compared to the tool data record that is present in the global database, and in the case of new tool information in the global database the user is notified that new tool information is present. The user may then actively approve or reject updating of the tool information. In principle, automatic updating of the tool data records from the global database to the local database at predetermined intervals is also conceivable; this does not appear to be meaningful for the reasons stated above.

Furthermore, a deviation, determined during the validation, of input tool information from previously validated data in the global database may trigger a follow-up action. When a deviation in the input data is determined, for example a notification, in particular an automatic notification, may be sent to the inputting user. Possible damage due to the use of incorrect tool information by the user may thus be prevented. A subsequent comparison of the data and/or an exchange with the user results in further improvement of the quality of the data that are present, and thus the quality of the integrity.

In particular, checking of manufacturers' tool data may be offered as a service to tool manufacturers, by comparing the database of the manufacturer to the global database or by validating the data during input into the global database.

The method thus has the advantage that users may access tool data records that are already validated by the input of tool information or tool data records by other users, and in return enter their tool data records in order to contribute to the validation of tool data records that are already present, and/or for expanding and supplementing tool data records for other users. On the one hand, by the provision, in particular the automatic provision, of validated data, the method prevents input errors due to manual input, which is still common. On the other hand, use is made of the synergy effect of swarm intelligence, explained above, for improving the data quality and the integrity of the data as well as for reducing the effort for generating tool data records, which may have a positive effect on the production costs. The method thus increases reliability in the use of tool data records, and may contribute to a reduction in production costs.

The global database may be located, for example, on a platform that is provided on a server. The user may directly access the platform, for example via a web service or some other user interface. This approach using a local database, which is usually selected for companies, has the advantage that all employees of the company have access to the local database as users. The identities of the users may optionally be assigned within the local database to the input tool information, so that these identities are also visible to other users of the local database. In both cases, tool information can be input via a desktop or mobile terminal application, or some other user interface.

Alternatively, the access to the global database or a local database may be dependent on a license agreement that is selectable by the user. This may involve a recurring or one-time payment, or may take place and/or be limited via login of the users, or other parameters which are explained in greater detail below. Login may have the advantage, for example, that misuse of the local database or global database by intentionally incorrect entries may be avoided or at least minimized. In the case that the global database is operated, for example, by a supplier of machining tools, also simply referred to below as tools, access to the global database, or at least to certain functions of the global database, or the provision of a local database may also be enabled strictly for customers of the supplier. In the case of the local databases described above, access by the employee users may be determined by the company user. The users enter their available tool information about a used tool into an input mask. The input mask may specify, for example, the input of certain standard dimensions of the tools, and may also include freely selectable parameters. The required parameters and/or the minimum number of parameters that must be entered in order to make an input of a data record into the database possible at all may also be defined for each tool. A required parameter may in particular be a unique identification number for the tool, for example the tool number assigned by the manufacturer or supplier. To simplify the input, selection lists for each required parameter may be contained in the input mask, or after one of the required parameters is input, further required parameters may be selected by the user by choosing from a series of suggested values. A required parameter may be, for example, a nominal diameter of a milling head. The database advantageously specifies a standardized form of the input and saving of the data records, and also assigns a unique identification number to a tool which unambiguously identifies the tool. Alternatively, a tool may be uniquely defined by a certain required parameter—for a drill, for example, the diameter, the length, or the material, to name only a few of the required parameters that are possible for a unique definition. During input of the tool data records, there may be different values for a parameter, for example the nominal diameter for a milling head. During the validation, based on multiple tool data records for a tool input, a validated value may be determined for each parameter, which is standardized in a practical manner as explained above.

The validation may take place based on agreeing parameters concerning tool information of a tool data record. All data concerning tool information items that are added by various users, directly to the global database or indirectly via the local database, may be used.

Furthermore, the validation may be carried out based on a plausibility criterion, as a result of which outliers in the data are detected and are not considered further in the validation of tool information item.

In particular, the plausibility criterion may be formed as a threshold value. The threshold value may be, for example, a maximum deviation of an input value from the average value of all input values.

In addition, the threshold value may be a percentage. Thus, based on a likelihood with a confidence interval, both of which may be expressed as percentages, a statement about the quality may be made. Furthermore, an inadvertent incorrect input may be recognized as such and corrected. For example, if the nominal diameter is 50 for 99 out of 100 input tool data records, and is 49 for one tool data record, the likelihood that this value is correct and must be considered in the validation is extremely low. A percentage threshold value could be defined, for example, in such a way that upon agreement of a parameter for 80% of the input tool data records, the value is deemed as 100% validated. Gradations over the degree of validation are also conceivable.

The validation may be carried out based on an algorithm. The algorithm may determine a piece of information about the status or the quality of the tool information to be validated, for example based on the number of input tool information items and further parameters that are determined from the input tool information items.

The algorithm may be executed using a computer. The validation of the tool data records by the algorithm may thus be carried out automatically or essentially automatically. In particular in conjunction with the automatic transmission of the input tool information in the local databases to the global database, explained above, the quality of the tool data records is automatically improved, and in a continuous manner with an increasing number of users.

The validation, as mentioned above, is based on the comparison of multiple inputs of a tool information item (nominal diameter of a milling head), it being possible to use different mathematical methods for validating the tool information, depending on the type of tool information. Individual values as well as ranges may be indicated as tool information. The ranges are advantageous in particular for the above-described machine parameters corresponding to the tool, where a rotational speed range, for example, may be indicated. In addition, for some material information items, tolerances may also be indicated, so that, for example, a nominal value having a tolerance is stored in the database. For a certain tool/material combination, examples of such are feed rate and spindle rotational speed, or also the ratio of the feed rate to the spindle rotational speed.

Furthermore, the tool information may include empirical values obtained by the users from the use of the machining tools and/or tool machines. These empirical values may include, for example the service life of the machining tool or also preferred settings of the tool machines for a machining tool during the machining of certain materials. This has the advantage that the users of the database may profit from the experiences of other users of the database. The empirical values for the particular machining tools can advantageously only be input together in conjunction with the tool machine used and/or the material that is machined. This allows a specific assignment of the empirical values to certain tool machines and machined materials, which other users or, in the case of a company, employee users, can access.

In particular, users of certain tools may be identifiable to other users. This means, for example, that users of standard tools are identifiable to other users of the database. In this way, an exchange among the users may take place, and a bilateral exchange between two users may be enabled. In contrast, the users of special tools cannot be identified for reasons of secrecy.

In addition, users of tools may be identifiable to certain users. Depending on the status that is assigned to the certain user, to be explained in greater detail below, this user can identify other users who for example have a different status.

An overall configuration of a corresponding tool machine may be suggested, based on a tool that is selected by a user. This has the advantage that a user of the local database for a tool machine may use data that are input by other users and validated by the algorithm. This may advantageously reduce the production costs due to fewer test parts and a shorter programming duration for the CNC program.

In particular, the user may choose the corresponding tool machine from a selection of offered tool machines. The tool machines offered in the input mask, for example, may be based on the tool information that is input by the users, and on the empirical values obtained from the use of the machining tools and/or tool machines.

An overall configuration of a tool machine for producing the part may be suggested, based on a digital data record of a part that is input by a user. The overall configuration may include a selection of suitable tool machines, required tools, setting parameters of the tools on the tool machine, and a CNC program that is created for the tool machine. In addition to the data that are relevant for the production, metadata such as projected manufacturing times, cost calculations, dimensions for raw materials, and further data may also be transmitted. On the one hand, the information items required for this purpose may be derived from the tool information that is input by other users or from empirical values of the tool data records, and on the other hand, the database may be linked to other methods, for example a method for creating a machining sequence from a digital data record of a part or the like.

Furthermore, the global database may also be linked to further systems, for example online stores for tools or CAD CAM systems for use of the tool data records. For access to the further systems, various payment methods are conceivable, for example monthly fees or billing for individual accesses to the global database.

As stated above, the functions described in the above examples of the method, such as the identification of a user of certain tools and/or the option for certain users to identify further users of tools, may be made accessible, as a function of a status of the user, which is likewise saved in the database. The status of the user may depend on different parameters, and can allow access to various usage models of the database.

For example, the following steps by the user may be necessary to allow the method steps, explained in the method steps described above, to be carried out.

It is conceivable, for example, for a user to go through a login process before using the database for input and/or obtaining information.

This may include at least the input of a unique identification feature of the user and at least one communication channel in the form of an address, a mailing address, or a telephone number.

A user can obtain information items from the database only after inputting a predetermined number and/or quality of information items into the database.

The number and/or quality of the information items may be determined, for example, from the number of input tool data records and/or from the scope and quality of the information items present in the individual tool data records.

A user may have to pay a fee for the information that is available from the database.

This may be designed in the form of different payment models, for example a one-time payment or subscriptions, or also in the form of monetary credits received for the input of information.

These additional method steps explained above allow an unambiguous determination of the status of the user, and thus provide an option to technically implement in particular the provision of information from the database within the scope of the method described above.

A database according to the invention for providing tool data records for machining tools is designed so that the database can validate the tool data records according to the above-described methods. Due to the validation of the tool data records based on multiple inputs for the same tool information of a uniquely identifiable tool, the database may advantageously improve the data quality. As explained above, the use of tool data records that are validated by the database reduces the risk that the part to be manufactured, the machining unit, or other devices or persons taking part in the manufacture are damaged/injured due to incorrect tool data records. The validated tool data records thus advantageously reduce the production costs on account of the lower reject rate during the manufacture of parts, in particular when setting up the machining unit for a new part and the associated extra effort. In addition, the machining units and their operators may be protected from damage/injury. The database may have a web-based design as a global database, and via an interface may be linked to local databases and/or machining units and/or CNC programs. The transmission of data to or from the global database may take place manually, automatically, or by a combination of the two.

A system according to the invention for manufacturing parts comprises an engineering data management system and a machining unit, wherein the engineering data management system and the machining unit are connected to one another in such a way that data may be exchanged between the engineering data management system and the machining unit. According to the invention, the engineering data management system includes at least one database according to the example described above.

An engineering data management (EDM) system involves the integrated, structured, and consistent management of all processes and data that are present during the development of new products or the revision of existing products, the so-called engineering of the product, over the entire product life cycle. The engineering data management system is closely related to the product data management, and overlaps in many areas. The engineering data management system generally includes, in addition to product data management, a document management system and production data management. Possible data and documents that may be managed by an engineering data management system are the following: product configurations (parts lists, for example), CAD models and CAD drawings, any types of documents in electronic and non-electronic form, image files, (C) NC programs, and project and work plans.

The database may be designed, for example, as part of the production data management, but in the sense of a modular system may also be designed as an independent module.

The system can continuously improve the tool data records in the database due to the option for exchanging the validation of the tool data records, in particular the machine parameters and the material data of the part to be manufactured, corresponding to the machine parameters, between the machining unit and the database. The data quality as well as the integrity of the tool data records are thus continuously improved, and added value is created for the user.

Due to the automation of the data transfer between the database and the machining unit and/or the CNC program, which is present in the method explained above, the system may be designed as a self-learning or artificial intelligence-based system by means of an algorithm that is used for validating the tool data records.

Furthermore, in addition to access to the machining unit, the database may also be used on further systems that are linked to the engineering data management system, for example CAx applications, i.e., computer-aided systems, and product planning systems (PPSs), and optionally to other sources for further, in particular automated, use of tool information for validating the tool data records.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawings which are given by way of illustration only, and thus, are not limitive of the present invention, and wherein the sole FIGURE shows a flow chart for a method according to the invention.

### DETAILED DESCRIPTION

The FIGURE describes a possible method via which the provision of tool data records for machining tools may be simplified.

A global database for receiving the tool data records is provided in a first method step 1.

Tool information items concerning the tool data records are added by users of the machining tools in a second method step 2.

At least one tool data record for a certain machining tool is validated in a third method step 3, based on a comparison of a plurality of tool information items concerning at least one comparable parameter of this machining tool.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for providing tool data records for machining tools, the method comprising:
providing a global database for receiving the tool data records;
adding tool information items to the tool data records by a user and/or a manufacturer of the machining tools; and
validating at least one tool data record for a certain machining tool, based on a comparison of a plurality of tool information items concerning at least one comparable parameter of this machining tool.

2. The method according to claim 1, wherein at least portions of the tool data records are transmitted to users for use in the design and/or production of parts.

3. The method according to claim 1, wherein at least a portion of a tool data record is transmitted directly to a machining unit that is defined as a user and/or to a CNC program for a machining unit for use in the manufacture of parts.

4. The method according to claim 2, wherein an information item concerning the status of the validation of the tool data record is also included in the transmission of at least a portion of the tool data record to a user.

5. The method according to claim 2, wherein the user utilizes a local database with an interface to the global database for addition and/or for transmission.

6. The method according to claim 5, wherein tool information that is input into the local database by the user is automatically transmitted to the global database.

7. The method according to claim 1, wherein tool information items or the machine parameters utilized during use of the tool, are automatically transmitted from a machining unit and/or from a CNC program for a machining unit to the global database.

8. The method according to claim 5, wherein the tool data records present in a local database are at least partially updated with updated tool data records from the global database after an active request and/or agreement.

9. The method according to claim 1, wherein the validation takes place based on agreeing parameters concerning tool information of a tool data record or wherein the validation is carried out based on a plausibility criterion.

10. The method according to claim 9, characterized in that the plausibility criterion is a threshold value.

11. The method according to claim 10, wherein the threshold value is a percentage.

12. The method according to claim 1, wherein the validation is carried out based on an algorithm or wherein the validation is carried out based on the algorithm that is executed on a computer.

13. The method according to claim 1, wherein the tool information includes empirical values obtained by the user from the use of the machining tools and/or tool machines.

14. The method according to claim 1, wherein users of certain tools are identifiable to other users or wherein users of tools are identifiable to certain users.

15. The method according to claim 1, wherein an overall configuration of a corresponding tool machine is suggested, based on a tool that is selected by a user or wherein the user chooses the corresponding tool machine from a selection of offered tool machines.

16. The method according to claim 1, wherein an overall configuration of a tool machine for producing the part is suggested, based on a digital data record of a part that is input by a user.

17. The method according to claim 1, wherein a user goes through a login process before using the database for input and/or obtaining information.

18. The method according to claim 1, wherein a user obtains information items from the database only after inputting a predetermined number and/or quality of information items into the database.

19. The method according to claim 1, wherein a user must pay a fee for the information that is available from the database.

20. A database for providing tool data records for machining tools, wherein the database is designed to validate the tool data records according to the method of claim 1.

21. A system for manufacturing parts, the system comprising:
an engineering data management system; and
a machining unit,
wherein the engineering data management system and the machining unit are connected to one another such that data is exchanged between the engineering data management system and the machining unit, and
wherein the engineering data management system includes at least one database according to claim 20.
